(19) United States
(12) Patent Application Publication
(10) Pub. No.: US 2012/0048828 A1
(43) Pub. Date: Mar. 1, 2012

(54) METHOD OF MANUFACTURING CONDUCTIVE TRANSPARENT SUBSTRATE

(75) Inventors: Woon Chun Kim, Gyunggi-do (KR); Yong Soo Oh, Gyunggi-do (KR); Hyun Jun Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/956,297

(22) Filed: Nov. 30, 2010

(30) Foreign Application Priority Data
Aug. 26, 2010 (KR) 1020100082974

(51) Int. Cl. H01B 13/00

(52) U.S. Cl. 216/13

(57) ABSTRACT

Disclosed herein is a method of manufacturing a conductive transparent substrate. The method of manufacturing a conductive transparent substrate includes (A) forming a transparent electrode on one surface of a transparent film; (B) forming a release function film on a portion of the transparent electrode on which a pattern is formed; (C) removing the outside of the transparent electrode exposed on the transparent film; (D) removing the release function film; and (E) forming a pattern on the transparent electrode from which the release function film is removed, whereby it is possible to prevent the transparent electrode from being damaged due to washing water, thereby making it possible to improve manufacturing reliability.

### CROSS REFERENCE TO RELATED APPLICATION

This application claims the benefit of Korean Patent Application No. 10-2010-0082974, filed on Aug. 26, 2010, entitled “Method of Manufacturing Conductive Transparent Substrate,” which is hereby incorporated by reference in its entirety into this application.

### BACKGROUND OF THE INVENTION

1. Technical Field

The present invention relates to a method of manufacturing a conductive transparent substrate.

2. Description of the Related Art

Recently, current techniques for input devices exceed the level of fulfilling general functions and thus are progressing towards techniques related to high reliability, durability, innovation, designing and manufacturing. To this end, a touch screen has been developed as an input device capable of inputting information such as text and graphics.

The touch screen is mounted on the display surface of an image display device such as an electronic organizer, a flat panel display including a liquid crystal display (LCD) device, a plasma display panel (PDP), an electroluminescence (El) element or the like, or a cathode ray tube (CRT), so that a user selects the information desired while viewing the image display device.

The touch screen can be classified into a resistive type, a capacitive type, an electromagnetic type, a surface acoustic wave (SAW) type, and an infrared type. The type of touch screen selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch screen. Currently, a resistive touch screen and a capacitive touch screen are prevalently used.

The resistive touch screen is manufactured in a structure where a first transparent film formed with a first transparent electrode and a second transparent film formed with a second transparent electrode face each other, having a dot spacer therebetween. Therefore, when the resistive touch screen is touched by fingers or a pen, for example, the first transparent substrate disposed on the second transparent electrode is bent such that the first and second transparent electrodes are in contact with each other. At this time, the resistive touch screen senses the change in resistance value at the contact portion to recognize coordinates.

The capacitive touch screen is manufactured in a structure where the transparent electrode is formed between the first and second transparent films stacked up and down. Therefore, when the upper film is touched by fingers or a conductive pen, the capacitive touch screen senses the change in capacitance of the transparent electrode at the touched portion to recognize coordinates.

The transparent film may be made of glass or polyethylene terephthalate (PET), or the like and the transparent electrode may be made of a conductive polymer such as indium tin oxide (ITO), indium zinc oxide (IZO), Al-doped ZnO (AZO), carbon nano tube (CNT), {poly (3,4-ethylenedioxythiophene)} (PEDOT), or the like.

Reviewing the configuration of the resistive touch screen or the capacitive touch screen, the common configuration thereof is that the transparent electrode is formed on the transparent film. Hereinafter, the configuration that the transparent electrode is formed on the transparent film is called a ‘conductive transparent substrate’.

A method of manufacturing a conductive transparent substrate is configured to include forming a transparent electrode on a transparent film; forming a photoresist on the transparent electrode; removing the outside of the transparent electrode on which the photoresist is not formed; removing the photoresist; and forming a pattern on the transparent electrode from which the photoresist is removed.

In this case, the removing the photoresist performs a washing process washing the photoresist with washing water. There is a problem in that the transparent electrode is damaged due to the washing water during this process. For example, the washing water is infiltrated into the conductive polymer during the washing process, thereby causing the phenomenon that the resistance value of the conductive polymer is increased.

### SUMMARY OF THE INVENTION

The present invention has been made in an effort to provide a method of manufacturing a conductive transparent substrate for preventing a transparent electrode from being damaged due to a washing process.

A method of manufacturing a conductive transparent substrate according to a first preferred embodiment of the present invention includes: (A) forming a transparent electrode on one surface of a transparent film; (B) forming a release function film on a portion of the transparent electrode on which a pattern is formed; (C) removing the outside of the transparent electrode exposed on the transparent film; (D) removing the release function film; and (E) forming a pattern on the transparent electrode from which the release function film is removed.

At step (B), the release function film may be formed by a printing method.

The printing method may be a gravure printing method.

At step (C), the outside of the transparent electrode may be removed by an etching method.

At step (E), a patterning may be performed on the transparent electrode by any one of a laser method and a plasma method.

A method of manufacturing a conductive transparent substrate according to a second preferred embodiment of the present invention includes: (A) forming a transparent electrode on one surface of a transparent film; (B) forming a release function film on the transparent electrode, the release function film being a type corresponding to a pattern formed on the transparent electrode; (C) removing the transparent electrode exposed on the transparent film; and (D) removing the release function film.

At step (B), the release function film may be formed by a printing method.

The printing method may be a gravure printing method.

At step (C), the outside of the transparent electrode may be removed by an etching method.

### BRIEF DESCRIPTION OF THE DRAWINGS

FIG. 1 is a fixed plan view showing a method of manufacturing a conductive transparent substrate to which the present invention is applied;

FIG. 2 is a perspective view showing a state of removing a release function film in the method of manufacturing a conductive transparent substrate to which the present invention is applied;

FIGS. 3 to 7 are process cross-sectional views showing a first preferred embodiment of the method of manufacturing a conductive transparent substrate to which the present invention is applied; and

FIGS. 8 to 10 are process cross-sectional views showing a second preferred embodiment of the method of manufacturing a conductive transparent substrate to which the present invention is applied; and

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

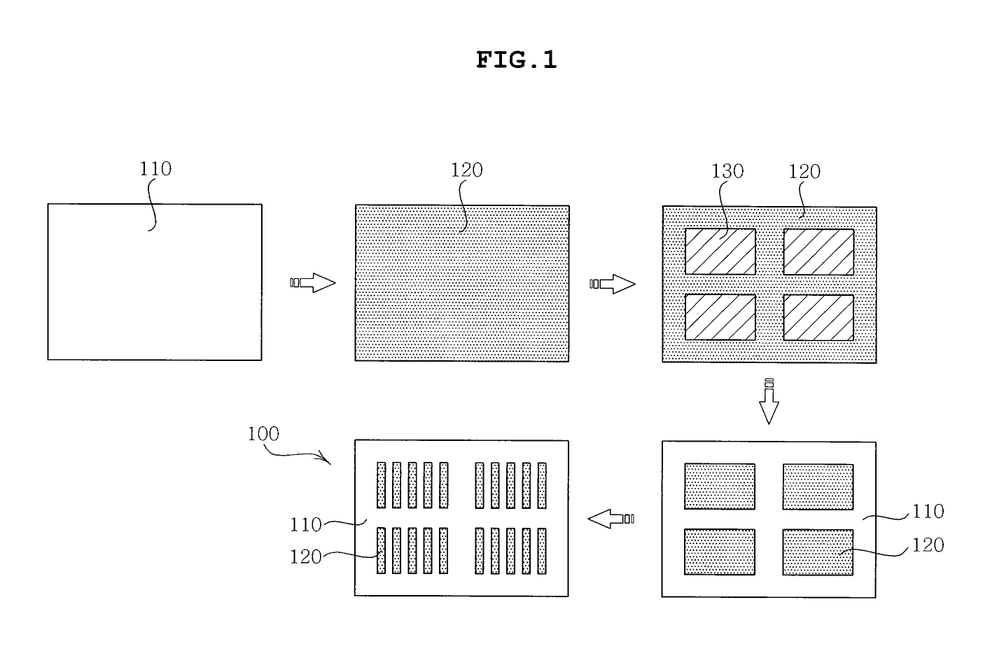

A method of manufacturing a conductive transparent substrate 100 according to the present invention is to form a transparent electrode 120 on a transparent film 110 by using a release function film 130 without using a washing process as shown in FIG. 1.

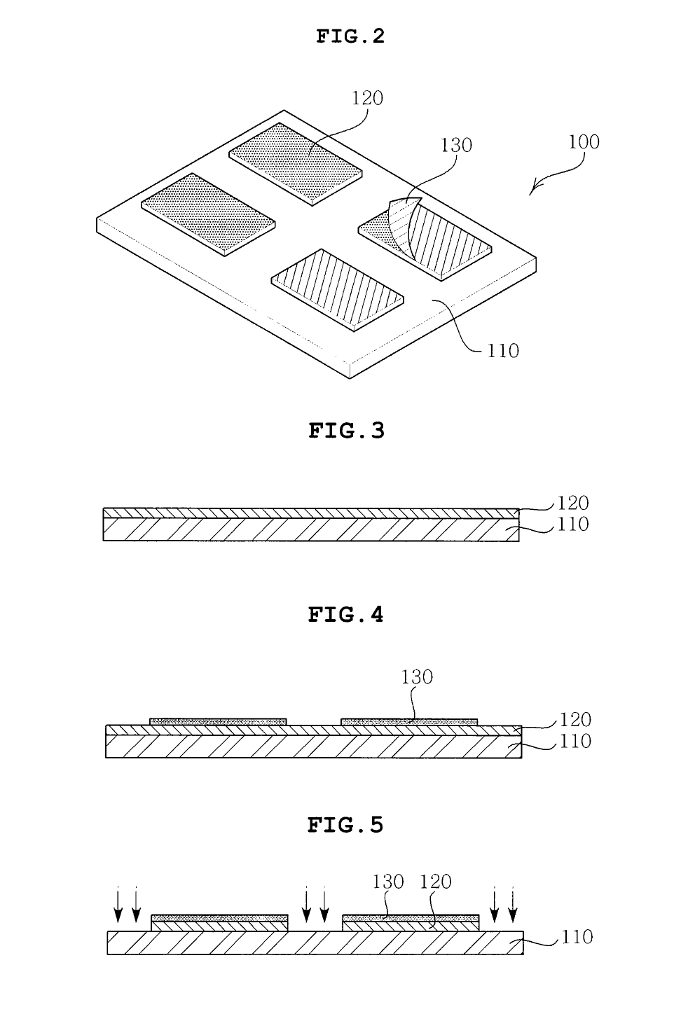

The release function film 130 may be removed by fingers or pincette in the state where an edge of the transparent electrode 120 formed on the transparent film 110 is removed, as shown in FIG. 2.

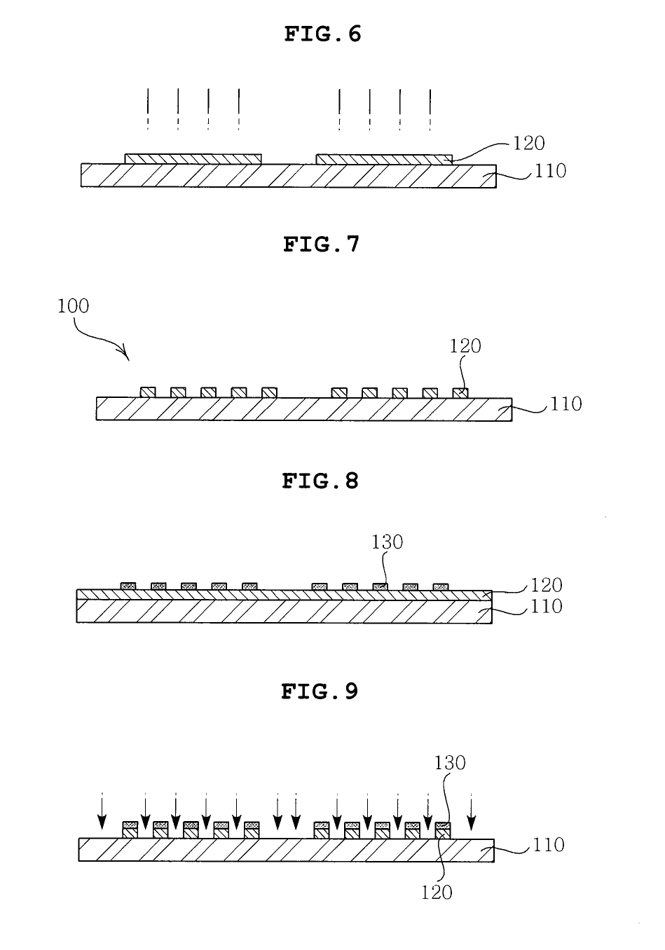

As the first preferred embodiment of the method of manufacturing a conductive transparent substrate 100, as shown in FIGS. 3 to 7, the method is configured to include (A) forming the transparent electrode 120 on one surface of the transparent film 110, (B) forming the release function film 130 on a portion of the transparent electrode 120 on which a pattern is formed, (C) removing the outside of the transparent electrode 120 exposed on the transparent film 110, (D) removing the release function film 130, and (E) forming a pattern on the transparent electrode 120 from which the release function film 130 is removed.

(A) the forming the transparent electrode 120 on one surface of the transparent film 110 applies the transparent electrode 120 over one surface of the transparent film 110.

The transparent film 110 may be made of a material having large durability in order to sufficiently protect the conductive transparent substrate 100 from an external force. In addition, the transparent film 110 is made of a transparent material to clearly transfer images from a display (not shown) to a user. As such a material, the transparent film 110 may, for example, be made of polyethyleneterephthalate (PET), polycarbonate (PC), polymethylmetacrylate (PMMA), polyethylenenaphthalate (PEN), polyethersulfone (PES) or cyclic olefin copolymer (COC). Besides, glass or tempered glass that are generally used may also be used.

The transparent electrode 120 is a member that is formed on the transparent film 110 to sense several electrical signals. When the conductive transparent substrate 100 is used as the touch screen, the transparent electrode 120 can sense signals by an input. In the case of a capacitive touch screen, for example, the transparent electrode 120 senses the change in capacitance from the input and transfers the change in capacitance to a controller (not shown), and the controller (not shown) recognizes coordinates of the pressed position, thereby making it possible to implement desired operations. The transparent electrode 120 may be made of, conductive polymer, such as, for example, indium tin oxide (ITO), indium zinc oxide (IZO), Al-doped ZnO (AZO), carbon nano tube (CNT), PEDOT, or the like, and silver (Ag) or copper (Cu) transparent ink, or the like.

(B) the forming the release function film 130 on the portion of the transparent electrode 120 on which the pattern is formed is to remove the transparent electrode 120 in a non-active region while the transparent electrode 120 in the active region of the transparent film 110 remains.

For example, FIGS. 1 and 2 show that four transparent electrodes 120 are formed on one transparent film 110. In this case, the transparent film 110 is used by being cut into four regions each including one transparent electrode 120.

The release function film 130 is, for example, formed by a printing method. As the printing method, there are a silk screen printing method, an inkjet printing method, a gravure printing method, or an offset printing method.

The embodiment of the present invention uses the printing method using the gravure printing method. The gravure printing method fills ink in a concave portion of a plate as compared with a convex plate, applies pressure to the ink, and transits it to a printed matter.

The release function film 130 may be formed of, for example, peelable ink. The peelable ink, which is printed to protect a specific portion, is not etched by an etchant and after it is printed, may be easily peeled-off by using hands or pincette.

(C) the removing the outside of the transparent electrode 120 exposed on the transparent film 110 is to remove the transparent electrode 120 remaining in the non-active region of the transparent film 110.

The outside of the transparent electrode 120 is removed by, for example, an etching method. Therefore, since the release function film 130 is formed of the peelable ink not to be removed by the etching method, when the etchant is put in the transparent substrate 100, only the transparent electrode 120 of the portion in which the release function film 130 is not formed is removed.

At (D) the removing the release function film 130, the release function film may be removed by hands or pincette, not by using the washing process. That is, since the release function film 130 is made of a material, which is strong against an etchant but can be easily peeled off, like the peelable ink, it can be easily removed manually by using hands or pincette.

At (E) the forming the pattern on the transparent electrode 120 from which the release function film 130 is removed, the pattern is directly formed on the transparent electrode 120 by any one of, for example, a laser method or a plasma method.

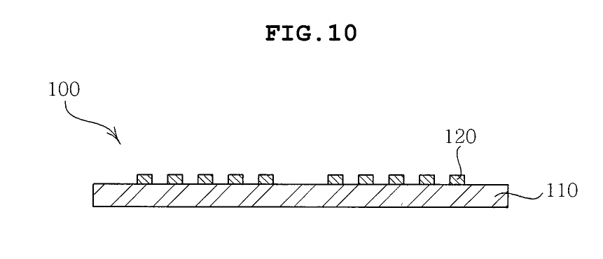

As the second preferred embodiment of the method of manufacturing a conductive transparent substrate 100, as shown in FIGS. 8 to 10, the method is configured to include (A) forming the transparent electrode 120 on one surface of the transparent film 110, (B) forming the release function film 130 on the transparent electrode 120, the release function film 130 being a type corresponding to a pattern formed on the transparent electrode 120, (C) removing the transparent electrode 120 exposed on the transparent film 110, and (D) removing the release function film 130.

In this case, the difference between the second preferred embodiment and the above-mentioned first preferred embodiment is that the release function film 130 itself is formed in a type corresponding to the pattern on the transparent electrode 120 during the process of forming the release function film 130 on the transparent electrode 120. Therefore, during the process of removing the transparent electrode 120 after the release function film 130 is formed, the pattern is formed on the transparent electrode 120 while removing the outside of the transparent electrode 120.

As a result, the second preferred embodiment can reduce the process of forming the pattern by the laser or the plasma method after the release function film 130 is removed, which is employed in the first exemplary embodiment. As such, the process of patterning the transparent electrode 120 is reduced, such that the burden to prepare the expensive laser apparatus or plasma apparatus can be reduced.

In this case, (B) the forming the release function film 130 on the transparent electrode 120, the release function film 130 being a type corresponding to a pattern formed on the transparent electrode 120, may be formed by the printing method using, for example, the gravure printing method, as described above.

(C) the removing the transparent electrode 120 exposed on the transparent film 110 between the release function films while removing the outside of the transparent film, by using, for example, the etching method, thereby forming the pattern on the transparent electrode 120.

According to the present invention, the method of manufacturing a conductive transparent substrate 100 uses the removable release function film 130 to form the transparent electrode 120 without using the washing process to prevent the transparent electrode 120 from being damaged due to the washing water, thereby making it possible to improve manufacturing reliability.

According to the present invention, the method of manufacturing a conductive transparent substrate forms the transparent electrode by using the removable release function film, by not using the washing process, to prevent the transparent electrode from being damaged due to the washing water, thereby making it possible to improve the manufacturing reliability.

Although the preferred embodiments of the present invention have been disclosed for illustrative purposes, they are for specifically explaining the present invention and thus a method of manufacturing a conductive transparent substrate according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A method of manufacturing a conductive transparent substrate, comprising:
(A) forming a transparent electrode on one surface of a transparent film;
(B) forming a release function film on a portion of the transparent electrode on which a pattern is formed;
(C) removing the outside of the transparent electrode exposed on the transparent film;
(D) removing the release function film; and
(E) forming a pattern on the transparent electrode from which the release function film is removed.

2. The method of manufacturing a conductive transparent substrate as set forth in claim 1, wherein at step (B), the release function film is formed by a printing method.

3. The method of manufacturing a conductive transparent substrate as set forth in claim 2, wherein the printing method is a gravure printing method.

4. The method of manufacturing a conductive transparent substrate as set forth in claim 1, wherein at step (C), the outside of the transparent electrode is removed by an etching method.

5. The method of manufacturing a conductive transparent substrate as set forth in claim 1, wherein at step (E), a patterning is performed on the transparent electrode by any one of a laser method and a plasma method.

6. A method of manufacturing a conductive transparent substrate, comprising:
(A) forming a transparent electrode on one surface of a transparent film;
(B) forming a release function film on the transparent electrode, the release function film being a type corresponding to a pattern formed on the transparent electrode;
(C) removing the transparent electrode exposed on the transparent film; and
(D) removing the release function film.

7. The method of manufacturing a conductive transparent substrate as set forth in claim 6, wherein at step (B), the release function film is formed by a printing method.

8. The method of manufacturing a conductive transparent substrate as set forth in claim 7, wherein the printing method is a gravure printing method.

9. The method of manufacturing a conductive transparent substrate as set forth in claim 6, wherein at step (C), the outside of the transparent electrode is removed by an etching method.
